(19) United States
(12) Patent Application Publication
(10) Pub. No.: US 2015/0332167 A1
(43) Pub. Date: Nov. 19, 2015

(54) SYSTEM AND METHOD FOR MODELING AND/OR ANALYZING MANUFACTURING PROCESSES

(71) Applicants: Sanjeev Kaushal, Los Altos Hills, CA (US); Sukesh Janubhai Patel, Cupertino, CA (US)

(72) Inventors: Sanjeev Kaushal, Los Altos Hills, CA (US); Sukesh Janubhai Patel, Cupertino, CA (US)

(73) Assignee: TOKYO ELECTRON LIMITED, Tokyo (JP)

(21) Appl. No.: 14/276,349

(22) Filed: May 13, 2014

(51) Int. Cl. G06N 99/00; G05B 19/418

(52) U.S. Cl. CPC G06N 99/005; G05B 19/418; G05B 2219/45032

(57) ABSTRACT

Systems and techniques for modeling and/or analyzing manufacturing processes are presented. A dataset component generates a plurality of binary classification datasets based on process data associated with one or more fabrication tools. A learning component generates a plurality of learned models based on the plurality of binary classification datasets and applies a weight to the plurality of learned models based on a number of data samples associated with the plurality of binary classification datasets to generate a weighted plurality of learned models. A merging component merges the weighted plurality of learned models to generate a process model for the process data.

### TECHNICAL FIELD

The described and claimed subject matter relates generally to techniques for modeling and/or analyzing manufacturing processes.

### BACKGROUND

Technological advances have lead to process-driven automated equipment that is increasingly complex. A tool system to accomplish a specific goal or perform a specific, highly technical process can commonly incorporate multiple functional elements to reach the goal or successfully execute the process, and various sensors that collect data to monitor the operation of the equipment. Such automated equipment can generate a large volume of data. Data can include information related to a product or a service performed as a part of the specific task and/or sizable log information related to the process. For example, process data and/or metrology data can be collected during a manufacturing process and/or stored in one or more datasets.

While modern electronic storage technologies can afford retaining constantly increasing quantities of data, utilization of the accumulated data remains far from optimal. Examination and interpretation of collected information generally requires human intervention. For example, a process on a semiconductor manufacturing tool may run for seventeen hours (e.g., 61,200 seconds). During processing, the semiconductor manufacturing tool may output sensor measurements every second via, for example, several hundred sensors. Accordingly, large datasets that include the output sensor measurements must then be manually studied (e.g., by process engineers) during process development and/or troubleshooting activities. Furthermore, when a process related to the semiconductor manufacturing tool is concluded, qualities (e.g., thickness, particle count) for several wafers generated by the semiconductor manufacturing tool must be manually measured (e.g., by manufacturing engineers).

However, in many cases, accurate numerical metrology (e.g., thickness, taper angle, etc.) is not available and/or is not provided to tool equipment engineers when a process related to the semiconductor manufacturing tool is concluded. As such, weak metrology indicators (e.g., good/bad wafers, etc.) are often employed to determine performance and/or quality of wafers. For example, a wafer associated with a particular acceptable performance can be designated as a “good wafer” and a wafer associated with a particular inadequate performance can be designated as a “bad wafer”. However, current techniques for determining performance and/or quality of wafers can be improved.

The above-described deficiencies of today's fabrication systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary of the specification in order to provide a basic understanding of some aspects of the specification. This summary is not an extensive overview of the specification. It is intended to neither identify key or critical elements of the specification, nor delineate any scope of the particular implementations of the specification or any scope of the claims. Its sole purpose is to present some concepts of the specification in a simplified form as a prelude to the more detailed description that is presented later.

In accordance with an implementation, a system includes a dataset component, a learning component and a merging component. The dataset component generates a plurality of classification datasets (e.g., a plurality of binary classification datasets, a plurality of ternary datasets, etc.) based on process data associated with one or more fabrication tools. The learning component generates a plurality of learned models (e.g., a plurality of learned binary models, a plurality of learned ternary models, etc.) based on the plurality of classification datasets and applies a weight to the plurality of learned models based on a number of data samples associated with the plurality of classification datasets to generate a weighted plurality of learned models (e.g., a weighted plurality of learned binary models, a weighted plurality of learned ternary models, etc.). The merging component merges the weighted plurality of learned models to generate a process model for the process data.

In accordance with another implementation, a method provides for receiving a dataset associated with process data for one or more fabrication tools, generating a plurality of classification datasets based on a number of classes included in the process data, generating one or more learned functions for each of the plurality of classification datasets, and combining the one or more learned functions for each of the plurality of classification datasets to generate a process model associated with the process data.

In accordance with yet another implementation, a computer-readable medium having stored thereon computer-executable instructions that, in response to execution by a system including a processor, cause the system to perform operations, the operations including generating a plurality of binary classification datasets associated with a unique classification for a unit of processing based on process data, generating one more learned functions for each of the plurality of binary classification datasets, and generating a process model for the process data by merging the one more learned functions for each of the plurality of binary classification datasets.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 is block diagram illustrating an exemplary system for modeling and/or analyzing processes relating to semiconductor production, in accordance with various aspects and implementations described herein;

FIG. 2 is a block diagram illustrating an exemplary model component, in accordance with various aspects and implementations described herein;

FIG. 3 is a block diagram illustrating an exemplary analysis component, in accordance with various aspects and implementations described herein;

FIG. 4 is block diagram illustrating another exemplary system for modeling and/or analyzing processes relating to semiconductor production, in accordance with various aspects and implementations described herein;

FIG. 5 illustrates an exemplary data matrix, in accordance with various aspects and implementations described herein;

FIG. 6 illustrates an exemplary transformation of a dataset, in accordance with various aspects and implementations described herein;

FIG. 7 illustrates another exemplary transformation of a dataset, in accordance with various aspects and implementations described herein;

FIG. 8 illustrates an exemplary dataset, in accordance with various aspects and implementations described herein;

FIG. 9 illustrates an exemplary binary classification dataset, in accordance with various aspects and implementations described herein;

FIG. 10 illustrates another exemplary binary classification dataset, in accordance with various aspects and implementations described herein;

FIG. 11 illustrates yet another exemplary binary classification dataset, in accordance with various aspects and implementations described herein;

FIG. 12 is a flowchart of an example methodology for generating a process model, in accordance with various aspects and implementations described herein;

FIG. 13 is a flowchart of another example methodology for generating a process model, in accordance with various aspects and implementations described herein;

FIG. 14 is a flowchart of another example methodology for generating a process model, in accordance with various aspects and implementations described herein;

FIG. 15 is a schematic block diagram illustrating a suitable operating environment; and

FIG. 16 is a schematic block diagram of a sample-computing environment.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

Technological advances have lead to process-driven automated equipment that is increasingly complex. A tool system to accomplish a specific goal or perform a specific, highly technical process can commonly incorporate multiple functional elements to reach the goal or successfully execute the process, and various sensors that collect data to monitor the operation of the equipment. Such automated equipment can generate a large volume of data. Data can include information related to a product or a service performed as a part of the specific task and/or sizable log information related to the process. For example, process data and/or metrology data can be collected during a manufacturing process and/or stored in one or more datasets.

While modern electronic storage technologies can afford retaining constantly increasing quantities of data, utilization of the accumulated data remains far from optimal. Examination and interpretation of collected information generally requires human intervention. For example, a process on a semiconductor manufacturing tool may run for seventeen hours (e.g., 61,200 seconds). During processing, the semiconductor manufacturing tool may output sensor measurements every second via, for example, several hundred sensors. Accordingly, large datasets that include the output sensor measurements must then be manually studied (e.g., by process engineers) during process development and/or troubleshooting activities. Furthermore, when a process related to the semiconductor manufacturing tool is concluded, qualities (e.g., thickness, particle count) for several wafers generated by the semiconductor manufacturing tool must be manually measured (e.g., by manufacturing engineers).

However, in many cases, accurate numerical metrology (e.g., thickness, taper angle, etc.) is not available and/or is not provided to tool equipment engineers when a process related to the semiconductor manufacturing tool is concluded. As such, weak metrology indicators (e.g., good/bad wafers, etc.) are often employed to determine performance and/or quality of wafers. For example, a wafer associated with a particular acceptable performance can be designated as a “good wafer” and a wafer associated with a particular inadequate performance can be designated as a “bad wafer”. However, current techniques for determining performance and/or quality of wafers can be improved.

To that end, techniques for modeling and/or analyzing manufacturing processes to generate more accurate process models and/or to improve prediction for a unit of processing (e.g., a wafer) are disclosed. Multiple viewpoint predictors (e.g., based on classifiers) can be employed to model and/or analyze process data associated with a manufacturing process. For example, a classifier (e.g., a binary classifier, a ternary classifier, etc.) can be associated with each class (e.g., n-classes, where n is an integer) included in the process data. Then, a problem dataset (e.g., a binary classification dataset, a ternary classification dataset, etc.) can be generated for each identified class of the classifier (e.g., the binary classifier, the ternary classifier, etc.). In a non-limiting example, in response to a determination that process data is associated with three classifiers, a first problem dataset associated with a first classifier, a second problem dataset associated with a second classifier, and a third dataset associated with a third classifier can be generated. Thus, it can be determined whether each unit of processing (e.g., each wafer) is associated with the first classier based on a first problem dataset, whether each unit of processing is associated with the second classier based on a second problem dataset, and whether each unit of processing is associated with the third classier based on a third problem dataset. A plurality of learned functions (e.g., learned models) associated with the problem datasets can be generated based on one or more learning algorithms. In an aspect, data associated with the plurality of learned functions can be weighed based on number of samples associated with the problem datasets. The plurality of learned functions can then be combined to acquire a predictive model (e.g., a predictive process model). Accordingly, a set of units of processing (e.g., a set of wafers) with associated classifiers can be analyzed to identify a particular variable (or a set of variables) that can be employed to separate one classier from another classier (e.g., to identify which variable(s) can separate a class of wafers from another class of wafers). Furthermore, an available set of variables can be employed to predict a class of a unit of processing (e.g., a wafer) before metrology is performed and/or a class is designated for the unit of processing.

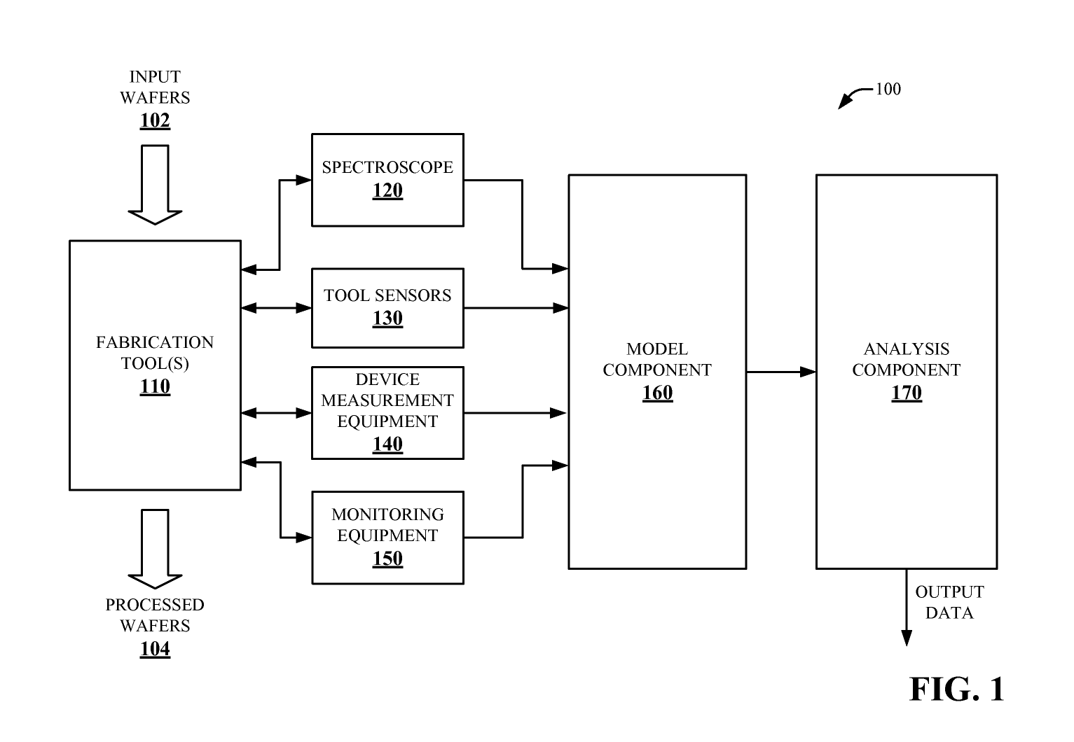

Referring initially to FIG. 1, there is illustrated an example system 100 for modeling and/or analyzing processes related to manufacturing (e.g., semiconductor production), according to an aspect of the subject disclosure. System 100 can include fabrication tool(s) 110, spectroscope 120, tool sensors 130, device measurement equipment 140, monitoring equipment 150, model component 160 and/or analysis component 170. Fabrication tool(s) 110 can include one or more tools and/or one or more chambers for manufacturing (e.g., semiconductor fabrication). In an aspect, fabrication tool(s) 110 can be associated with a semiconductor fabrication system. For example, as shown in FIG. 1, fabrication tool(s) 110 can receive input wafers 102 and output processed wafers 104. However, it is to be appreciated that fabrication tool(s) 110 can receive and/or generate a different type of asset (e.g., different units of processing). In an exemplary, non-limiting embodiment, fabrication tool(s) 110 can be an etch tool that removes unmasked material from input wafers 102 via an etching process (e.g., wet etch, dry etch, plasma etching, etc.) to generate processed wafers 104 having cavities and features formed thereon. Fabrication tool(s) 110 can also be a deposition tool (e.g., atomic layer deposition, chemical vapor deposition, etc.) that deposits material onto input wafers 102 to yield processed wafers 104. However, it is to be appreciated that fabrication tool(s) 110 can be associated with a different type of fabrication system.

A variety of measurement devices, such as spectroscope 120, tool sensors 130, device measurement equipment 140 and/or monitoring equipment 150, can monitor one or more processes performed by fabrication tool(s) 110 to acquire disparate information relating to various aspects, conditions and/or results of the process. As an example, spectroscope 120 can acquire spectral data (e.g., spectral intensity information). For example, spectral data can include a set of intensities for respective wavelengths or spectral lines observable by spectroscope 120. In one example, spectral data can include time-series data such that spectroscope 120 measures intensities for respective wavelengths at regular intervals (e.g., every second, every two seconds, every 100 milliseconds, etc.). Spectroscope 120 can also correlate spectral data with wafer IDs associated with specific wafers processed by fabrication tool(s) 110. Accordingly, spectroscope 120 can acquire spectral data individually for each wafer processed by fabrication tool(s) 110.

Tool sensors 130 can monitor and/or measure tool operation characteristics while fabrication tool(s) 110 processes input wafers 102. Furthermore, tool sensors 130 can generate corresponding sensor measurement data. Sensor measurement data, similar to spectral data measured by spectroscope 120, can be time-series data correlated on a per-wafer basis. Sensor measurement data can include measurements from a variety of sensors. Such measurements can include, but are not limited to, pressures within one or more chambers of fabrication tool(s) 110, gas flows for one or more distinct gases, temperatures, upper radio frequency (RF) power, elapsed time associated with a process (e.g., elapsed time since last wet-clean, etc.), and the like. In an aspect, sensor measurement data can be associated with physical quantities. In another aspect, sensor measurement data can be associated with virtual quantities.

Device measurement equipment 140 can generate device measurement data. For example, device measurement equipment 140 can measure physical and geometric properties of wafers and/or features fabricated on wafers. For instance, device measurement equipment 140 can measure development inspection critical dimension (DI-CD), final inspection critical dimension (FI-CD), etch bias, thickness, and so forth, at predetermined locations or regions of wafers. The measured properties can be aggregated on a per-location, per-wafer basis and output as device measurement information. Properties of wafers are typically measured before processing or after processing. Accordingly, device measurement data can be time-series data acquired at a different interval as compared with spectral data and sensor data.

Monitoring equipment 150 can be implemented to acquire and/or generate monitoring data (e.g., maintenance data, classification data, etc.) associated with fabrication tool(s) 110 and/or processed wafers 104. For example, the monitoring equipment 150 can be implemented to acquire and/or generate maintenance data associated with fabrication tool(s) 110. Additionally or alternatively, the monitoring equipment 150 can be implemented to acquire and/or generate classification data associated with processed wafers 104. Maintenance data can include, but is not limited to, elapsed time since a last preventative maintenance, age of one or more components associated with fabrication tool(s) 110 (e.g., age of tool parts, production time associated with a component, etc.), and the like. Classification data can include, but is not limited to, a class (e.g., a designated class, a classifier value) associated with each unit of processing (e.g., processed wafers 104). In one example, classification data can be an integer value. In another example, classification data can be a character string (e.g., a color, a description, etc.).

A class associated with a unit of processing (e.g., a wafer) can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to infer performance and/or quality associated with a unit of processing. In an aspect, a support vector machine (SVM), naïve Bayes, Bayesian networks, decision trees, neural networks, fuzzy logic models, probabilistic classification models providing different patterns of independence and/or other directed and undirected model classification approaches can be employed to determine a class associated with a unit of processing.

Model component 160 can receive process data (and/or training data) acquired and/or generated by spectroscope 120, tool sensors 130, device measurement equipment 140 and/or monitoring equipment 150. In an aspect, model component 160 can receive the process data as the process data is generated (e.g., during an on-line mode). In another aspect, model component 160 can receive the process data upon completion of one or more processes associated with fabrication tool(s) 110. In an implementation, process data can be consolidated in a data matrix. For example, a data matrix can include wafer identification data, time data, sensor measurement data, spectral data and/or classification data. In another aspect, a data matrix (e.g., a new data matrix) can be generated incrementally to initiate a new learning cycle.

In an aspect, model component 160 can normalize process data. For example, model component 160 can normalize process data to account for error associated with fabrication tool(s) 110. For example, model component 160 can normalize spectral data (e.g., measured intensities) to account for measurement error of intensity of spectral lines in different tools and/or chambers included in fabrication tool(s) 110. In a non-limiting example, model component 160 can compute a variable (e.g., total light intensity) associated with an arbitrarily selected reference chamber or reference tool included in fabrication tool(s) 110 to normalize process data.

In one or more embodiments, process data can be derived from tool process logs that record parameter data and/or performance data measured during respective runs of fabrication tool(s) 110. Tool process logs can include measurement data from spectroscope 120, tool sensors 130, device measurement equipment 140 and/or monitoring equipment 150. Measurements recorded in such tool process logs can include, but are not limited to, sensor readings (e.g., pressures, temperatures, power, etc.), maintenance related readings (e.g., age of focus ring, age of mass flow controller, time since last performed maintenance, time since last batch of resist was loaded, etc.), and/or tool and performance statistics (e.g., time to process wafer, chemical consumption, gas consumption, etc.).

In an exemplary scenario, a tool process log can be generated by model component 160 at the end of each process run of fabrication tool(s) 110. At the end of a process run, data from one or more of the spectroscope 120, tool sensors 130, device measurement equipment 140, or monitoring equipment 150 can be provided to model component 160, which can aggregate the collected data in a tool process log for the run. A tool process log can correspond to a single semiconductor wafer processed during the run, or a batch of semiconductors fabricated during the run. The tool process logs can then be stored for reporting or archival purposes. In an aspect, process data can be provided automatically by model component 160 or a related device. In another aspect, process data can be provided to model component 160 manually by an operator. Although the foregoing example describes process data as being retrieved or extracted from tool process logs, it is to be appreciated that process data may also be provided to model component 160 by other means. For example, in some embodiments, all or a subset of process data may be provided directly to model component 160 from devices 120, 130, 140 and/or 150.

Model component 160 can generate a set of process models (e.g., one or more process models) based on the process data associated with the fabrication tool(s) 110. A process model can be a mathematical process model (e.g., a function). For example, a process model can be implemented to learn a mathematical process model for an output as a function of the process data (e.g., tunable inputs, input parameters, etc.). In an aspect, the set of process models can be generated using one or more genetic algorithms (e.g., genetic programming). In another aspect, the set of process models can be generated using a curve fitting technique. For example, a process model can be generated using linear approximation, multi-linear approximation, polynomial curve fitting, neural networks, linear regression, bagging, boosting, etc. However, it is to be appreciated that a process model can be generated using a different type of learning technique. In yet another aspect, model component 160 can generate a new process model in response to receiving new process data (e.g., new process data associated with a new run associated with fabrication tool(s) 110, new process data associated with a new step associated with a new run associated with fabrication tool(s) 110, etc.).

In an aspect, each process model in the set of process models can be associated with a different amount of process data. For example, a first process model can be associated with a first amount of process data, a second process model can be associated with a second amount of process data, etc. Additionally or alternatively, one or more of the process models in the set of process models can be associated with a different number of parameters (e.g., input parameters, tunable inputs, etc.). For example, a first process model can be associated with a first number of parameters, a second process model can be associated with a second number of parameters, etc. In another aspect, a user can specify a range (e.g., a minimum value, a maximum value, a mean value, a standard deviation value, etc.) for each of the parameters (e.g., input parameters, tunable inputs, etc.).

To facilitate generation of the set of process models, model component 160 can generate one or more datasets (e.g., binary classification datasets, ternary classification datasets, etc.) based on process data (e.g., process data, training data, etc.) acquired and/or generated by spectroscope 120, tool sensors 130, device measurement equipment 140 and/or monitoring equipment 150. In an aspect, the model component 160 can generate one or more datasets based on a matrix of the process data acquired and/or generated by spectroscope 120, tool sensors 130, device measurement equipment 140 and/or monitoring equipment 150. In another aspect, the model component 160 can transform the process data (e.g., execute one or more data transformations) to permit different frequencies of measurements for different variables. The model component 160 can generate modified process data that includes replicated data (e.g., replicated process data). Additionally or alternatively, the model component 160 can generate modified process data that includes summarized data (e.g., summarization attributes such as mean, standard deviation, etc.).

The model component 160 can generate the one or more datasets according to a number of different classes included in the process data (e.g., a number of different classifiers associated with the process data). For example, the model component 160 can generate three datasets in response to a determination that the process data includes three different classes (e.g., three different classes of data, three classifications, etc.). The one or more datasets can be binary classification datasets (or ternary classification datasets, or quaternion classification datasets, etc.). For example, process data included in each dataset can be classified as being associated with a particular classifier or not (e.g., binary classifiers for process data included in each dataset can be generated). In a non-limiting example, a three classification dataset where units of processing (e.g., wafers) are classified as “Good”, “Bad” or “OK” can be formulated as three binary classification models (e.g., a “Good/Not-Good” binary classification model, a “Bad/Not-Bad” binary classification model, and an “OK/Not-OK” binary classification model).

Additionally, the model component 160 can perform learning associated with the one or more datasets based on one or more learning algorithms (e.g., linear regression, bagging, boosting, another learning technique, etc.). The model component 160 can generate a set of learned functions (e.g., a set of learned models, a set of learned binary models, a set of learned ternary models, etc.) for each of the one or more datasets based on the learning. As such, each of the one or more datasets can be associated with one or more learned functions. A learned function can predict an output as a function of inputs based on a single problem dataset. In an embodiment, the number of learned functions to generate can be indicated (e.g., by an agent). In another embodiment, a weight can be applied to a learned function based on number of data samples included in a dataset associated with the learned function. The model component 160 can merge the set of learned functions to construct at least one process model (e.g., at least one prediction function). In an aspect, the model component 160 can merge learned functions from all problem datasets to construct a prediction based on a combination of the learned functions. The combination of the learned functions can be expressed as a function (e.g., a predictive function). Additionally, the combination of the learned functions can correspond to a model (e.g., a process model) for the process data received by the model component 160 (e.g., the process data acquired and/or generated by spectroscope 120, tool sensors 130, device measurement equipment 140 and/or monitoring equipment 150). The model (e.g., the prediction function) for the process data can be provided to the analysis component 170 for subsequent analysis and/or predictive purposes.

The analysis component 170 can be configured to generate a classification prediction for a unit of processing. For example, the analysis component 170 can predict a state of a unit of processing (e.g., a state of a wafer) given one or more input variables (e.g., an input tuple) for a process model (e.g., a prediction function) before metrology measurements are performed on the unit of processing. Additionally, the analysis component 170 can be configured to analyze and/or diagnose the model (e.g., the prediction function) generated by the model component 160. For example, the analysis component 170 can identify one or more input variables that influence a particular class being assigned to a unit of processing (e.g., the analysis component 170 can identify which input variables are responsible for particular class included in process data). The analysis component 170 can generate output data (e.g., OUTPUT DATA shown in FIG. 1). The output data generated by the analysis component 170 can include, but is not limited to, prediction data, input variable data (e.g., a ranking of input variables), analysis data and/or diagnosis data.

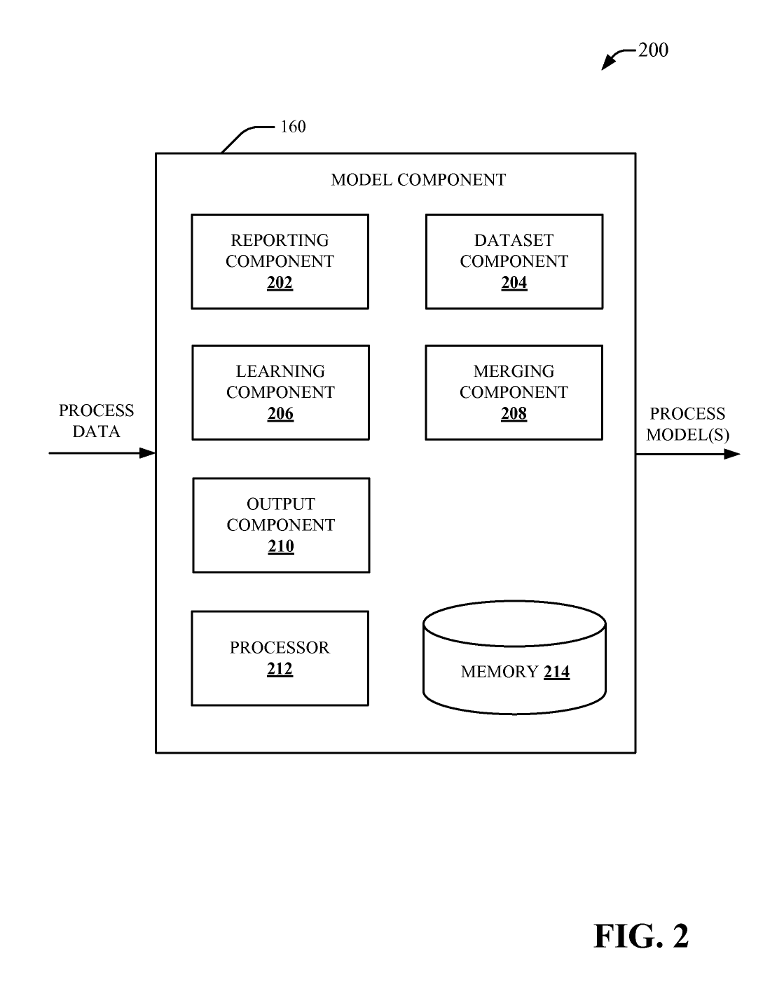

FIG. 2 illustrates a non-limiting implementation of a system 200 in accordance with various aspects and implementations of this disclosure. System 200 includes model component 160. Model component 160 can include a reporting component 202, a dataset component 204, a learning component 206, a merging component 208 and/or an output component 210. Aspects of system 200 can constitute machine-executable component(s) embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. In an embodiment, system 200 can include memory 214 for storing computer executable components and instructions. System 200 can further include a processor 212 to facilitate operation of the instructions (e.g., computer executable components and instructions) by system 200.

Reporting component 202 can receive process data (e.g., PROCESS DATA shown in FIG. 2). The process data can be associated with spectroscope 120, tool sensors 130, device measurement equipment 140 and/or monitoring equipment 150. In an aspect, the reporting component 202 can generate a data matrix based on the data associated with spectroscope 120, tool sensors 130, device measurement equipment 140 and/or monitoring equipment 150. For example, the reporting component 202 can integrate training data into a consolidate data matrix. In a non-limiting example, a data matrix can include a column associated with a unit of processing (e.g., a Wafer-ID field), a column associated with time that reports an elapsed time (e.g., elapsed seconds) for a process (e.g., a manufacturing process), one or more columns associated with tool sensor measurements, one or more columns associated with metrology measurements and/or a column associated with classification of a unit of processing (e.g., a classifier for a unit of processing). In an aspect, the process data can be associated with one or more steps (e.g., one or more distinct steps). As such, the data matrix can additionally include a column associated with step identification (e.g., a Step-ID column). However, it is to be appreciated that the data matrix can include other columns associated with other data.

The column associated with classification of a unit of processing (e.g., a wafer, etc.) can include a class for a unit of processing. A single class can be associated with a unit of processing for each time entry related to the process. A class can be an indicator (e.g., a metrology indicator) associated with performance and/or quality of a unit of processing. In one implementation, a class can be configured as a numerical number (e.g., −1, +1, etc.). In another implementation, a class can be configured as text string. In one example, a particular class can be designated as high, normal or low (e.g., high taper, normal taper, low taper, etc.). In another example, a particular class can be designated as Very-High-Consumption, High-Consumption, Normal-Consumption, Low-Consumption or Very-Low-Consumption. In yet another example, a class can be designated as Green, Yellow, or Red. However, it is to be appreciated that different text strings can be employed to classify a unit of processing.

In an aspect, reporting component 202 can transform the process data (e.g., generate modified process data that includes replicated data and/or summarized data). The reporting component 202 can replicate data associated with an input variable to correspond to a measurement frequency associated with another input variable. For example, if a particular input variable v1 is measured every second and another input variable v2 is measured every 10 seconds, the reporting component 202 can replicate data associated with the other input variable v2 (e.g., the less frequently measured variable). Alternatively, the reporting component 202 can summarize (e.g., consolidate) data associated with the particular input variable v1 (e.g., the more frequently measured variable). For example, the reporting component 202 can statistically summarize the particular input variable v1 (e.g., as a mean value, as a standard deviation value, etc.) so that the particular input variable v1 is associated with a smaller number of measurement values (e.g., is associated with a measurement value every 10 seconds instead of every second). The particular input variable v1 can be summarized by one or more columns (e.g., a column associated with a mean value of the particular input variable v1, a column associated with a standard deviation value of the particular input variable v1, etc.) based on a selected summarization (e.g., selected by the agent). In a non-limiting example, ten samples associated with the particular input variable v1 can be replaced by a single row with multiple columns to align.

The dataset component 204 can generate a plurality of datasets based on a classification of the process data associated with spectroscope 120, tool sensors 130, device measurement equipment 140 and/or monitoring equipment 150. The number of datasets generated by the dataset component 204 can correspond to the number of classes included in the process data (e.g., the number of different classifications associated with the process data). In a non-limiting example, if the data associated with spectroscope 120, tool sensors 130, device measurement equipment 140 and/or monitoring equipment 150 includes three different designated classes, then the dataset component 204 can generate three datasets. The plurality of datasets can be binary classification datasets generated based on process data associated with fabrication tool(s) 110. For example, classification data included in process data associated with fabrication tool(s) 110 can be classified (e.g., transformed) into two classification groups (e.g., −1 and +1, yes and no, etc.). However, it is to be appreciated that the plurality of datasets can be different classification datasets (e.g., ternary classification datasets, quaternion classification datasets, etc.). Each of the plurality of datasets can be associated with a unique classification for a unit of processing.

In an aspect, the plurality of datasets can be data matrices. For example, the dataset component 204 can modify a data matrix generated by the reporting component 202 to generate one or more modified data matrices. The dataset component 204 can modify a column of a data matrix that is associated with classification. In a non-limiting example where a data matrix includes three different designated classes, the dataset component 204 can generate a first modified data matrix for a first designated class where each instance of the first designated class can be modified to a first value (e.g., +1) and each instance of another designated class can be modified to a second value (e.g., −1), the dataset component 204 can generate a second modified data matrix for a second designated class where each instance of the second designated class can be modified to a first value (e.g., +1) and each instance of another designated class can be modified to a second value (e.g., −1), and the dataset component 204 can generate a third modified data matrix for a third designated class where each instance of the third designated class can be modified to a first value (e.g., +1) and each instance of another designated class can be modified to a second value (e.g., −1). As such, the dataset component 204 can generate N-learning problem datasets for an N-class classification, where N is an integer.

Given the one or more datasets generated by the dataset component 204 (e.g., N-binary problem datasets), the learning component 206 can generate a plurality of learned functions (e.g., a plurality of learned models, a plurality of learned binary models, a plurality of learned ternary models, etc.) based on the one or more datasets. A learned function (e.g., a learned model) can expresses an output as a function of inputs for a dataset. The plurality of learned functions can be generated based on one or more learning algorithms. One or more learned functions can be generated for each dataset generated by the dataset component 204. Additionally, the learning component 206 can apply a weight to data associated with the plurality of learned functions based on a number of data samples associated with the plurality of datasets to generate a weighted plurality of learned functions (e.g., a weighed plurality of learned models, a weighted plurality of learned binary models, a weighted plurality of learned ternary models, etc.). For example, the learning component 206 can employ weights to ensure that a particular learning algorithm accounts for the number of positive/negative samples in a dataset (e.g., a problem training dataset). In an example where a particular dataset includes six entries, a weight of ⅙ can be provided when a function outputs a −1 given a set of inputs and a weight of ⅚ can be provided when a function outputs a +1 given the set of inputs (e.g., a weight can be determined based on number of samples in the particular dataset). An example equation S that employs weights can be:

S=(NumOfTruePredictions/NumOfTrueWafers+NumofFalsePredictions/NumOfFalseWafers)/2

Therefore, weight equals 0 when S is less than 0.5, and weight equals 2*(S−0.5) when S is greater than or equal to 0.5.

The one or more learning algorithms employed by the learning component 206 can include, but not limited to, one or more genetic algorithms, one or more support vector machines, one or more regression algorithms (e.g., linear regression, etc.), one or more curve fitting techniques, linear approximation, multi-linear approximation, polynomial curve fitting, neural networks, ensemble learning (e.g., bagging, boosting, etc.) and/or another type of learning algorithm. However, it is to be appreciated that learning component 206 can implement a different type of learning algorithm and/or learning technique to generate a learned function. In one example, a learning algorithm can be a discrete learning algorithm (e.g., true/false). In another example, a learning algorithm can be a continuous learning algorithm −1 to 1 (e.g., false to true). In an aspect, an external agent can specify the number of learned functions m for each dataset, where m is an integer value greater than or equal to 1.

In an embodiment, the learning component 206 can increase the number of learned functions m and take an average or median of distinct m predictions (e.g., prediction functions) as a representative value for a particular classification dataset (e.g., a particular binary classification dataset). For example, in an example where n is the number of classification datasets, m is the number of repeated functions learned (e.g., prediction functions), and a mathematical average operator is an operator selected by an agent to generate a representative value from the m predictive functions, a plurality of classification datasets can be implemented as follows:

prediction₁=average (f₁¹(x), f₂¹(x), . . . , fₘ¹(x)) for a first problem dataset, prediction₂=average(f₁²(x), f₂²(x), . . . , fₘ²(x)) for a second problem dataset, and predictionₙ=average(f₁ⁿ(x), f₂ⁿ(x), . . . , fₘⁿ(x)) for an nth problem dataset.

As such, each representative value for the m-learned functions for a problem set can be a function. For example, prediction₁=F₁(f₁¹(x), f₂¹(x), . . . , fₘ¹(x)) for a first problem dataset, prediction₂=F₂(f₁²(x), f₂²(x), . . . , fₘ²(x)) for a second problem dataset, and predictionₙ=Fₙ(f₁ⁿ(x), f₂ⁿ(x), . . . , fₘⁿ(x)) for an nth problem dataset.

The merging component 208 can generate at least one process model (e.g., at least one functional relationship) for the process data associated with spectroscope 120, tool sensors 130, device measurement equipment 140 and/or monitoring equipment 150. The at least one process model can be a process model for one or more manufacturing processes associated with fabrication tool(s) 110. A process model can be a mathematical process model (e.g., a mathematical function). For example, a process model can be implemented to learn a mathematical process model for an output as a function of the process data. The process model can relate a particular classifier to a set of input variable (e.g., inputs).

The merging component 208 can merge at least a portion of the plurality of learned functions and/or the weighted plurality of learned functions to generate a process model for the process data (e.g., the merging component 208 can merge learned functions and/or weighted learned functions associated with the one or more datasets). For example, a merge process employed by the merging component 208 can be as follows:

$${E}_{class = 1} = \frac{{F}_{1} ( x ) + [ 1 - {F}_{2} ( x ) ] + … + [ 1 - {F}_{n} ( x ) ]}{n}$$

$${E}_{class = 2} = \frac{[ 1 - {F}_{1} ( x ) ] + {F}_{2} ( x ) + … + [ 1 - {F}_{n} ( x ) ]}{n}$$

$${E}_{class = n} = \frac{[ 1 - {F}_{1} ( x ) ] + [ 1 - {F}_{2} ( x ) ] + … + {F}_{n} ( x )}{n}$$

where Fᵢ(x) is a notation for Fᵢ (f₁ⁱ(x), f₂ⁱ(x), . . . , fₘⁱ(x)), the term E_{class=i} is a prediction estimate that a designated class given a tuple x when an input is i. Each E_{class=i} can be regarded as a continuous value whether each Fᵢ is a discrete Boolean valued function (e.g., true/false, 1/0, etc.) or each Fᵢ is a continuous valued function from −1 to +1 (e.g., false to true).

Given the prediction estimate for each class (e.g., E_{class=1}, E_{class=2}, . . . , E_{class=n}), the merging component 208 can perform an optimization sub-step as part of a merge process. The merging component 208 can employ available training data to output a Boolean valued prediction as follows:
(E_{class=1}>θ)=>{True},else{False}
(E_{class=2}>θ)=>{True},else{False}
(E_{class=n}>θ)=>{True},else{False}

As such, a predictive model can comprise a Boolean valued prediction for each class with a specific value assigned to θ. In an aspect, in the Boolean valued prediction equations above, true or false can be replaced by numeric values such as 1/0 or +1/−1, etc. for subsequent processing. The merging component 208 can employ an optimization process to investigate all values of θ from 0 to 1. Additionally, the merging component 208 can compute a prediction error for each of the investigated values of θ from 0 to 1. The merging component 208 can select θ such that prediction error is minimized given available training input tuples x₁ . . . xₜ, where t is an integer. Additionally, the merging component 208 can employ the selected value of θ with minimized prediction error to generate a prediction for a designated class of a unit of processing (e.g., a wafer) given a particular input tuple not included in a training set. In an aspect, the merging component 208 can rerun the optimization process for θ after each new tuple of input is received after a training set. As such, continuous improvement can be realized to minimize prediction error and/or to maximize prediction accuracy.

The output component 210 can output at least one process model (e.g., PROCESS MODEL(S) shown in FIG. 2). The at least one process model can be generated by the merging component 208. In an aspect, the output component 210 can reformat at least one process model generated by the merging component 208 into a format for subsequent processing. In one implementation, the output component 210 can output at least one process model generated by the merging component 208 as a single function (e.g., as single model) for predicting a state of a unit of processing. For example, the output component 210 can output a single function that takes as input two parameters and outputs a value of true or false (1 or 0, +1 or −1, etc.) as follows: o=F (x, class). In a non-limiting example, a function F([6,8.8], Green) can return a value of +1 or −1 based on a particular process model where [6,8.8] is notation for an input tuple where a first input variable V1 is equal to 6 and a second input variable V2 is equal to 8.8. In another implementation, the output component 210 can output at least one process model generated by the merging component 208 as a library of functions for predicting a state of a unit of processing.

While FIG. 2 depicts separate components in system 200, it is to be appreciated that the components may be implemented in a common component. In one example, the reporting component 202, the dataset component 204, the learning component 206 and/or the merging component 208 can be included in a single component. Further, it can be appreciated that the design of system 200 can include other component selections, component placements, etc., to facilitate generating at least one process model based on process data.

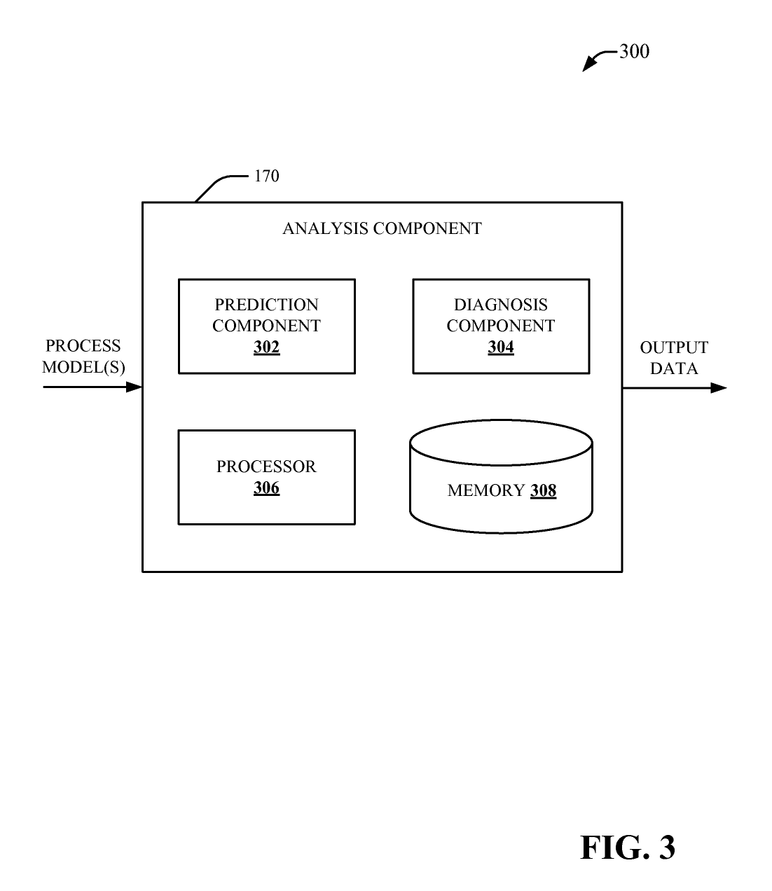

FIG. 3 illustrates a non-limiting implementation of a system 300 in accordance with various aspects and implementations of this disclosure. System 300 includes analysis component 170. Analysis component 170 can include a prediction component 302 and/or a diagnosis component 304. Aspects of system 300 can constitute machine-executable component(s) embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. In an embodiment, system 300 can include memory 308 for storing computer executable components and instructions. System 300 can further include a processor 306 to facilitate operation of the instructions (e.g., computer executable components and instructions) by system 300.

The prediction component 302 employ the at least one process model to predict a class associated with a unit of processing (e.g., a wafer) based on input variables (e.g., an input tuple, input parameters, etc.). The prediction component 302 can predict a class associated with a unit of processing before metrology is performed on the unit of processing and/or before a class is assigned to the unit of processing. For example, the prediction component 302 can predict a class for input wafers 102 provided to fabrication tool(s) 110 based on the at least one process model. As such, metrology costs can be lowered. Furthermore, production volume can be increased per unit of time (e.g., more units of processing can be produced within a certain time interval).

The diagnosis component 304 can employ the at least one process model for analysis and/or diagnosis purposes. The diagnosis component 304 can be configured to determine at least one input variable that influences a particular classification for a unit of processing (e.g., the diagnosis component 304 can be configured to identify input parameters that result in a particular classification for a unit of processing). For example, the diagnosis component 304 can identify one or more input variables that are responsible for a particular class being assigned to each of the processed wafers 104 generated by fabrication tool(s) 110. In a non-limiting example, the diagnosis component 304 can determine why a particular unit of processing produced by fabrication tool(s) 110 at time t for a particular recipe is assigned a particular classification, whereas a next unit of processing produced by fabrication tool(s) 110 employing the particular recipe is assigned another classification. In an aspect, the diagnosis component 304 can generate a ranking of input variables that are associated with a particular classification based on the at least one process model. For example, input variables can be ranked according to a degree of influence with respect to a particular classification for a unit of processing. As such, understanding of tool performance, understanding of the influence of input variables and/or efficiency of metrology runs can be improved.

While FIG. 3 depicts separate components in system 300, it is to be appreciated that the components may be implemented in a common component. In one example, the prediction component 302 and the diagnosis component 304 can be included in a single component. Further, it can be appreciated that the design of system 300 can include other component selections, component placements, etc., to facilitate generating output data based on at least one process model.

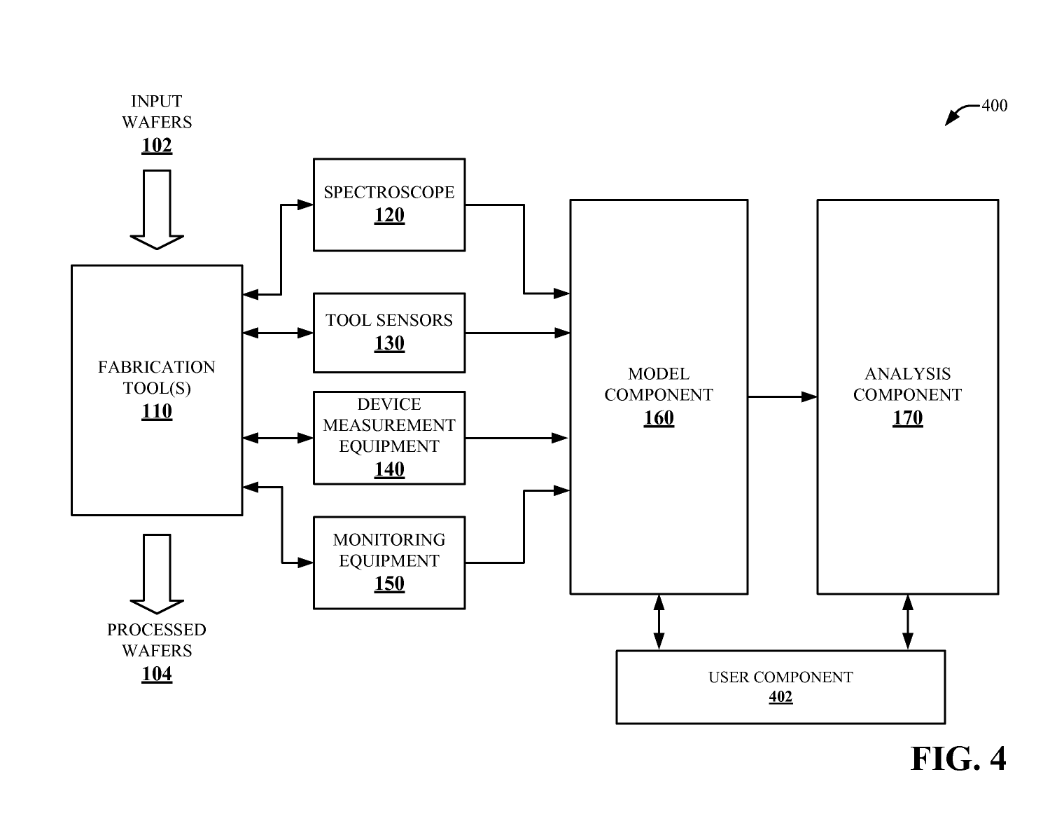

FIG. 4 is block diagram illustrating an exemplary system 400 for modeling and/or analyzing processes related to manufacturing (e.g., semiconductor production) based on user input. System 400 can include the fabrication tool(s) 110, the spectroscope 120, the tool sensors 130, the device measurement equipment 140, the monitoring equipment 150, the model component 160, the analysis component 170 and a user component 402. The model component 160 can include the reporting component 202, the dataset component 204, the learning component 206, the merging component 208 and/or the output component 210. The analysis component 170 can include the prediction component 302 and/or the diagnosis component 304.

User component 402 can be configured to receive input from a user of system 400. Additionally or alternatively, user component 402 can be configured to provide output to a user of system 400. For example, user component 402 can render an input display screen to a user that prompts for user specifications, and accept such specifications from the user via any suitable input mechanism (e.g., keyboard, touch screen, etc.). In an embodiment, the user component 402 can provide at least one process model, prediction data (e.g., a predicted classification of a unit of processing), analysis data associated with at least one process model, diagnosis data associated with at least one process model, and/or one or more input variables (e.g., a ranking of input variables) that are responsible for a particular classification associated with a unit of processing to a user via an output display screen. In an aspect, user component 402 can allow a user (e.g., an external agent) capability to include measurements at different frequencies such as power every 1/10th second, pressure every seconds, metrology every run, etc. In another aspect, user component 402 can allow a user (e.g., an external agent) to specify replication of data (e.g., less frequent readings can be replicated until a next reading of data), specify reduction of data (e.g., keep a row of data for a lowest frequency measurement, use a statistical summary of values of other less frequent samples) and/or use summarization of data (e.g., based on mean and/or a standard deviation). A statistical summary can include operations such as, but not limited to, a mean value, a min value, a max value, a range of values, a standard deviation value, etc. In yet another aspect, user component 402 can allow a user (e.g., an external agent) to mark a column of a data matrix as selected output and/or mark other columns of a data matrix as tunable process parameters (e.g., inputs).

In yet another aspect, user component 402 can allow a user (e.g., an external agent) to specify allowable range of values permitted for each tunable process parameter (e.g., each input parameters) associated with a process model. For example, user component 402 can allow a user to specify a range (e.g., a minimum value, a maximum value, a mean value, a standard deviation value, etc.) for each of the parameters (e.g., input parameters, tunable inputs, etc.). In yet another aspect, user component 402 can allow a user (e.g., an external agent) to specify an available size (e.g., number of slots for process models and/or solutions) of a memory. However, it is to be appreciated that user component 402 can be implemented to allow a user to specify (e.g., input) other types of information and/or data to facilitate modeling and/or analyzing processes related to manufacturing.

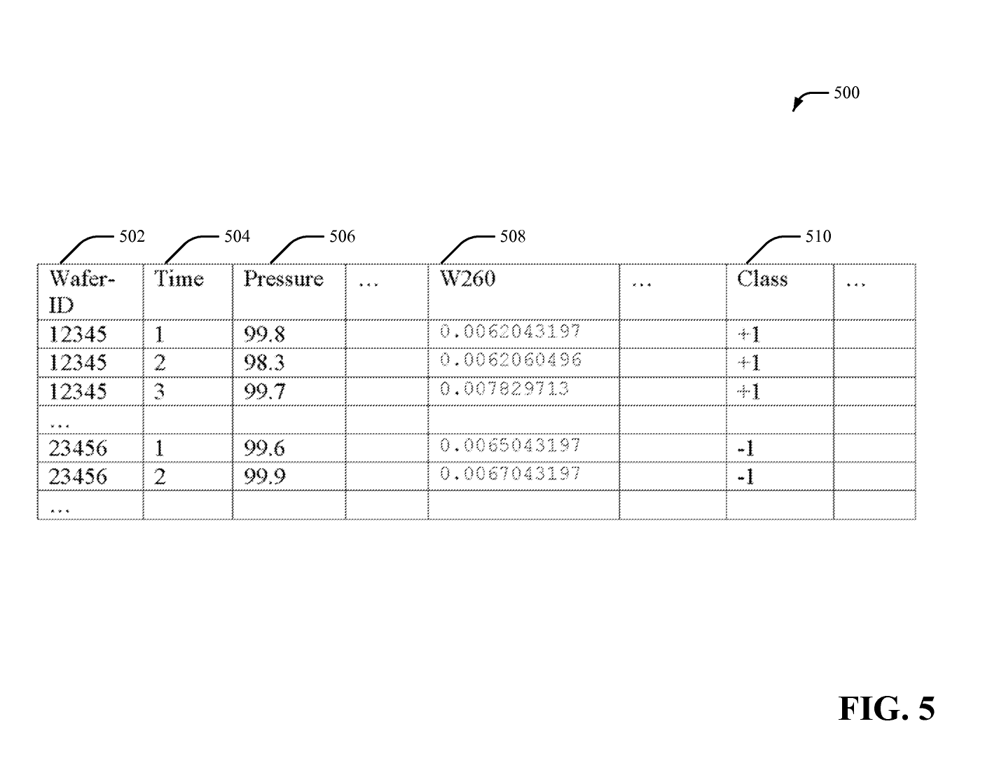

FIG. 5 is an exemplary data matrix 500 in accordance with various aspects and implementations of this disclosure. Data matrix 500 can facilitate modeling and/or analyzing processes related to manufacturing (e.g., semiconductor production). Process data associated with fabrication tool(s) 110 can be consolidated in the data matrix 500. For example, process data included in the data matrix 500 can be generated and/or acquired by spectroscope 120, tool sensors 130, device measurement equipment 140 and/or monitoring equipment 150. In an aspect, data matrix 500 can be generated by reporting component 202.

Data matrix 500 can include wafer identification data, time data, sensor measurement data, spectral data and/or classification data. Sensor measurement data can include, but is not limited to chamber pressure, gas flow, power data, elapsed time in seconds of a process, etc. Spectral data can include, but is not limited to, spectral intensities (e.g., tick by tick spectral measurements for all measured wavelengths), etc. Device measurement data can include, but is not limited to, dimension data, thickness, at one or more measurement targets on a wafer, etc. Classification data can include a numerical classier and/or a text string classifier related to a classification for a unit of processing. In an aspect, at least a portion of data included in the data matrix 400 can be provided via user component 402, modified via user component 402, selected via user component 402, etc.

In the non-limiting example shown in FIG. 5, data matrix 500 can include field 502, field 504, field 506, field 508 and field 510. For example, field 502 (e.g., Wafer-ID field) can capture a unit of processing (e.g., a wafer). Field 504 (e.g., Time field) can report elapsed time (e.g., elapsed seconds) for a process associated with the unit of processing (e.g., the wafer). In an aspect, the process may be partitioned into one or more steps. As such, data matrix 500 can additionally include a Step-ID field (not shown). Field 506 can include sensor measurement data. For example, one or more fields after a time field can include tool sensor measurement data. In FIG. 5, field 506 indicates pressure. However, it is to be appreciated that other type of sensor measurement data (e.g., such as, but not limited to, gas flow, power data, etc.) can additionally or alternatively be included in data matrix 500. Field 508 can include spectral data. For example, field 508 can include a spectra intensity measurement (e.g., wavelength ‘W260’). However, it is to be appreciated that other spectral data can additionally or alternatively be included in data matrix 500 (e.g., other wavelengths, etc.). In an aspect, an arbitrary number of spectral data (e.g., wavelengths) can be included in data matrix 500. Field 510 can include classification data (e.g., a class for a unit of processing). It is to be appreciated that data matrix 500 can additionally or alternatively include other types of data (e.g., maintenance data, etc.).

In an aspect, metrology measurements for obtaining data included in data matrix 500 can be performed prior to processing. In another aspect, metrology measurements for obtaining data included in data matrix 500 can be performed subsequent to processing. It is to be appreciated that a single metrology measurement or in-situ metrology can be implemented per unit of processing (e.g., per wafer). Furthermore, it is to be appreciated that other types of data can be included in data matrix 500 such as, but not limited to, throughput, efficiency, etc.

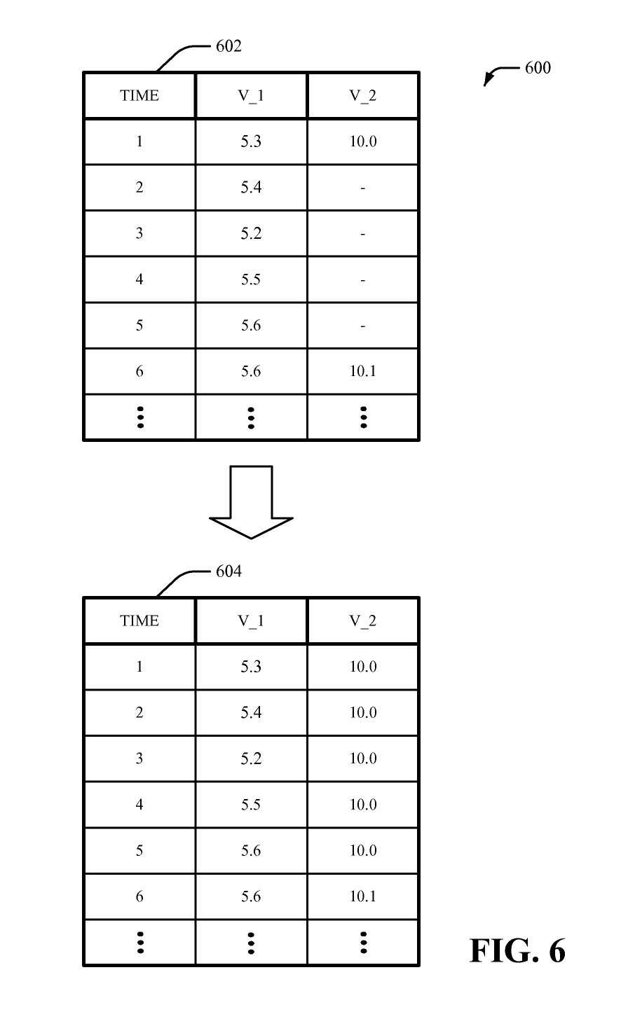

FIG. 6 illustrates an exemplary transformation 600 in accordance with various aspects and implementations of this disclosure. In an aspect, transformation 600 can be associated with the reporting component 202. A data table 602 includes a column for time, a column for a first input variable V_{—}1, and a column for a second input variable V_{—}2. However, it is to be appreciated that the data table 602 can include other columns. The first input variable V_{—}1 can be measured (e.g., captured) every second. The second input variable V_{—}2 can be measured (e.g., captured) every five seconds. The data table 602 can be transformed into a data table 604 by employing replication. For example, a value for the second input variable V_{—}2 at time 1 can be inserted into a value for the second input variable V_{—}2 at times 2-5. As such, process data (e.g., the second input variable V_{—}2) can be replicated so that data table 604 includes replicated process data (e.g., so that the second input variable V_{—}2 includes the same number of entries as the first input variable V_{—}1). Data table 602 and/or data table 604 can be implemented as at least a portion of a dataset and/or a data matrix.

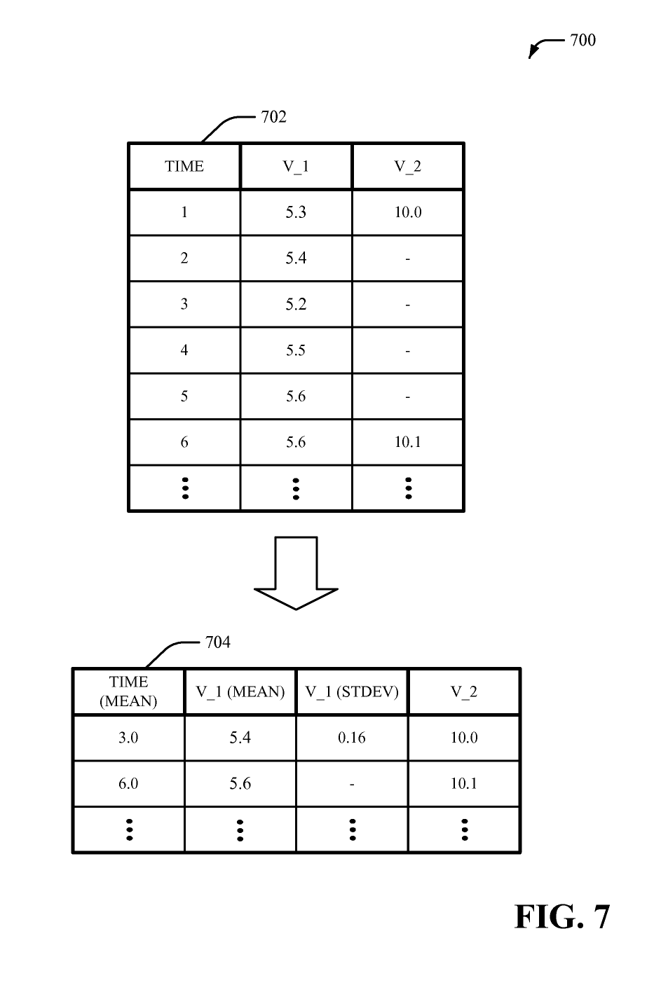

FIG. 7 illustrates an exemplary transformation 700 in accordance with various aspects and implementations of this disclosure. In an aspect, transformation 700 can be associated with the reporting component 202. A data table 702 includes a column for time, a column for a first input variable V_{—}1, and a column for a second input variable V_{—}2. However, it is to be appreciated that the data table 702 can include other columns. The first input variable V_{—}1 can be measured (e.g., captured) every second. The second input variable V_{—}2 can be measured (e.g., captured) every five seconds. The data table 702 can be transformed into a data table 704 by employing summarization. For example, values for the first input variable V_{—}1 corresponding to time 1-5 in the data table 702 can be summarized by a mean value and a standard deviation value in the data table 704. In an embodiment, mean and standard deviation can be summarization attributes selected by a user (e.g., via user component 402). In the example shown in FIG. 7, the mean value the first input variable V_{—}1 entries corresponding to times 1-5 (e.g., 5.3, 5.4, 5.2, 5.5 and 5.6) in the data table 702 is equal to 5.4. Furthermore, the standard deviation for the first input variable V_{—}1 entries corresponding to times 1-5 (e.g., 5.3, 5.4, 5.2, 5.5 and 5.6) in the data table 702 is equal to 0.16. Therefore, the data table 704 can summarize times 1-5 for the first input variable V_{—}1 in the table 702 as a time (mean) value of 3.0, a V_{—}1 (mean) value of 5.4 and a V_{—}1 (stdev) value of 0.16. Data for the first input variable V_{—}1 corresponding to time 6 and data for the second input variable V_{—}2 can be the same in the data table 702 and in the data table 704. For example, the mean value for the first input variable V_{—}1 entry corresponding to time 6 (e.g., 5.6) is equal to 5.6. A standard deviation value for the first input variable V_{—}1 entry corresponding to time 6 is not determined (e.g., standard deviation is not determined for a single input variable entry). As such, the number of entries for the first input variable V_{—}1 can be reduced to correspond to the number of entries for the second input variable V_{—}2. Data table 702 and/or data table 704 can be implemented as at least a portion of a dataset and/or a data matrix.

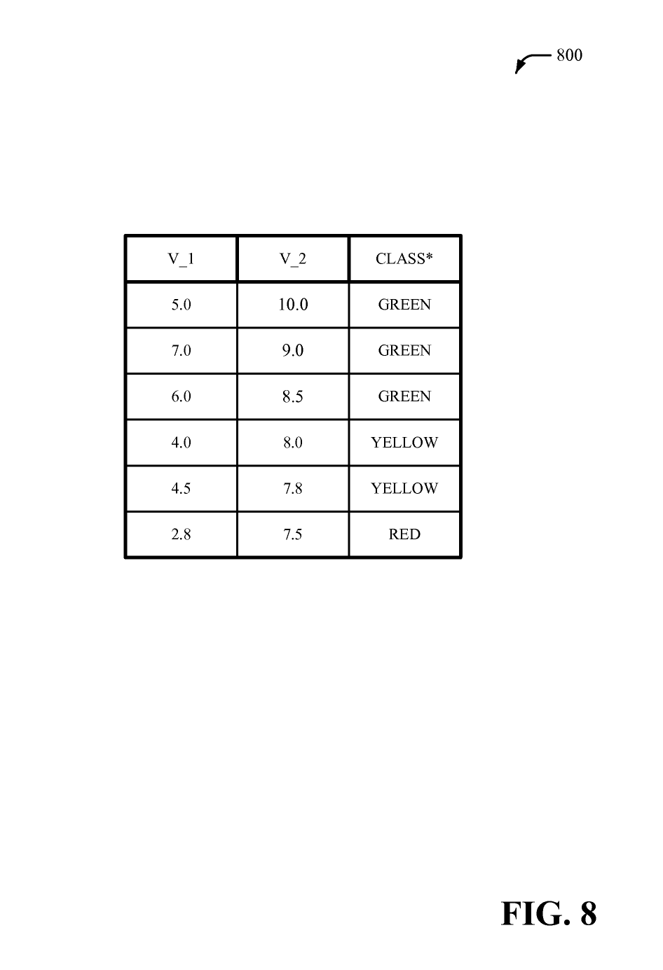

FIG. 8 is an exemplary input dataset 800 in accordance with various aspects and implementations of this disclosure. In an aspect, input dataset 800 can be a dataset received by the dataset component 204. The input dataset 800 can be a class input training dataset. In an aspect, the input dataset 800 can be process data received by the dataset component 204. As such, the input dataset 800 can be an example dataset (e.g., process data) employed by the dataset component 204 to generate one or more datasets (e.g., one or more binary classification datasets). Data included in the input dataset 800 includes three classifiers (e.g., three assigned designated classes for units of processing). For example, a designated class for three units of processing (e.g. three wafers) included in the input dataset 800 can be “Green”, a designated class for two units of processing included in the input dataset 800 can be “Yellow”, and a designated class for one unit of processing included in the input dataset 800 can be “Red”. In an aspect, a column in the input dataset 800 associated with classification can be marked by a unique symbol that is not found in input or output variable names. For example, a column in the input dataset 800 associated with classification can be marked by an asterisk “*”. The number of designated classes included in the input dataset 800 can determine the number of datasets that are generated (e.g., by the dataset component 204). For example, three datasets (e.g., three binary classification datasets) can be generated based on the number of classes included in the input dataset 800 (e.g., number of classifiers associated with the input dataset 800).

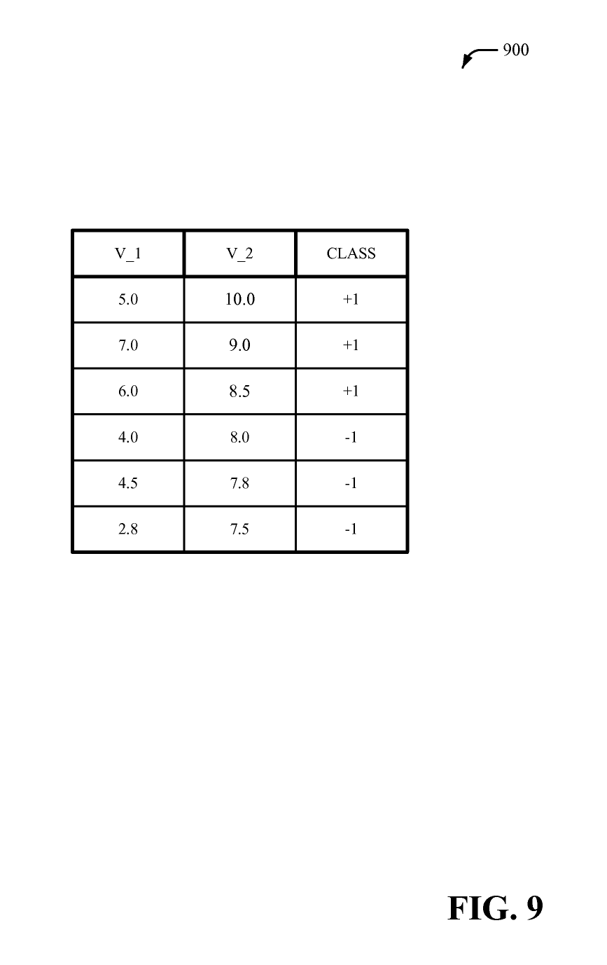

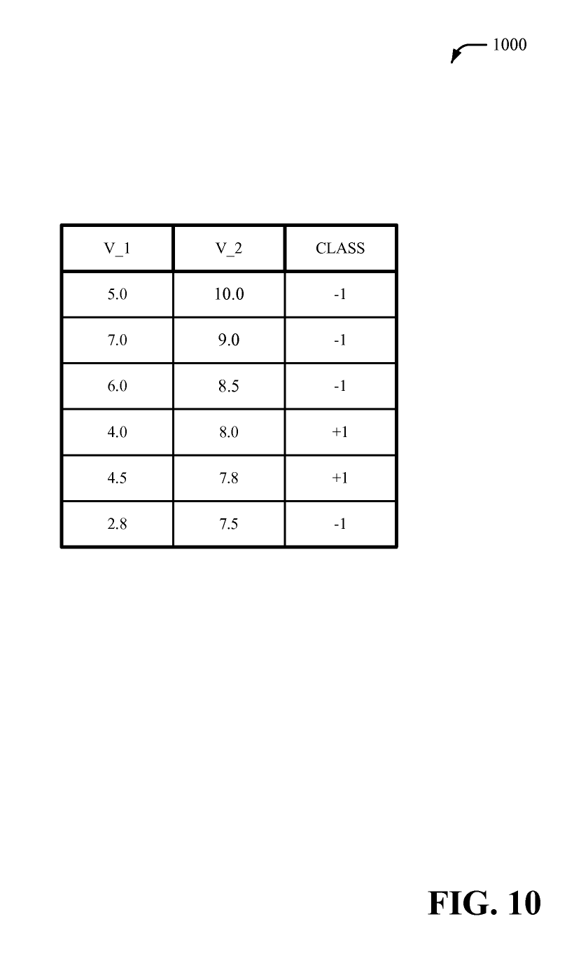

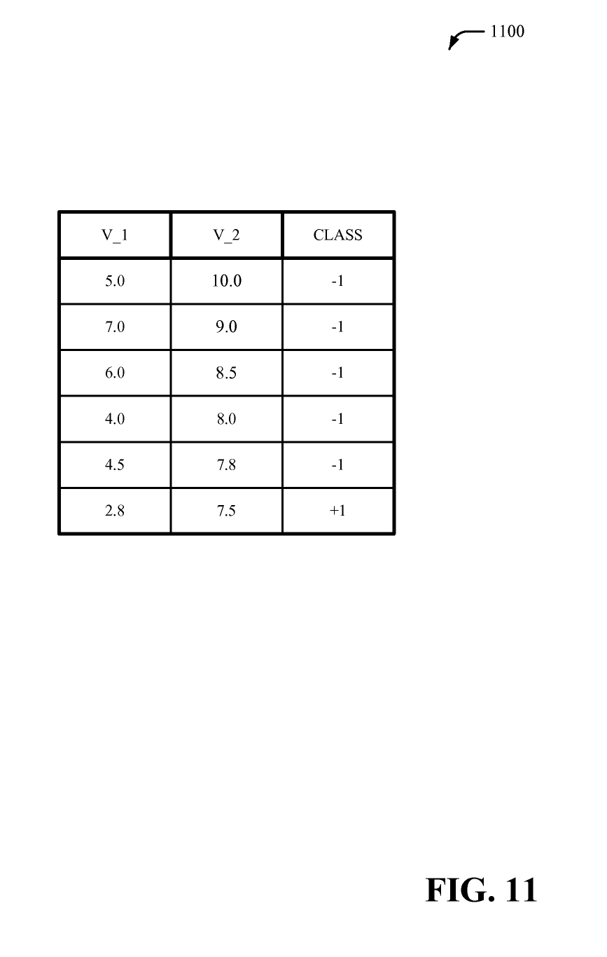

FIG. 9 is a first exemplary binary classification dataset 900 for the input dataset 800, FIG. 10 a second exemplary binary classification dataset 1000 for the input dataset 800, and FIG. 11 is a third exemplary binary classification dataset 1100 for the input dataset 800. The binary classification dataset 900, the binary classification dataset 1000 and/or the binary classification dataset 1100 can be generated by the dataset component 204. For example, the dataset component 204 can identify a first class (e.g., “Green”) in the input dataset 800, a second class (e.g., “Yellow”) in the input dataset 800, and a third class (e.g., “Red”) in the input dataset 800. As such, the binary classification dataset 900 can be associated with the first class (e.g., “Green”), the binary classification dataset 1000 can be associated with the second class (e.g., “Yellow”), and the binary classification dataset 1100 can be associate with the third class (e.g., “Red”).

The binary classification dataset 900, the binary classification dataset 1000 and the binary classification dataset 1100 can each be configured for binary classification. For example, in the binary classification dataset 900, +1 can indicate that a unit of processing is classified as Green and −1 can indicate that a unit of processing is not classified as Green. Furthermore, in the binary classification dataset 1000, +1 can indicate that a unit of processing is classified as Yellow and −1 can indicate that a unit of processing is not classified as Yellow. Moreover, in the binary classification dataset 1100, +1 can indicate that a unit of processing is classified as Red and −1 can indicate that a unit of processing is not classified as Red. As such, N-binary binary classification datasets can be generated based on an N-class classification dataset. The binary classification dataset 900, the binary classification dataset 1000 and the binary classification dataset 1100 can be further processed by the learning component 206 and/or the merging component 208 to facilitate generation of at least one process model for process data associated with the input dataset 800.

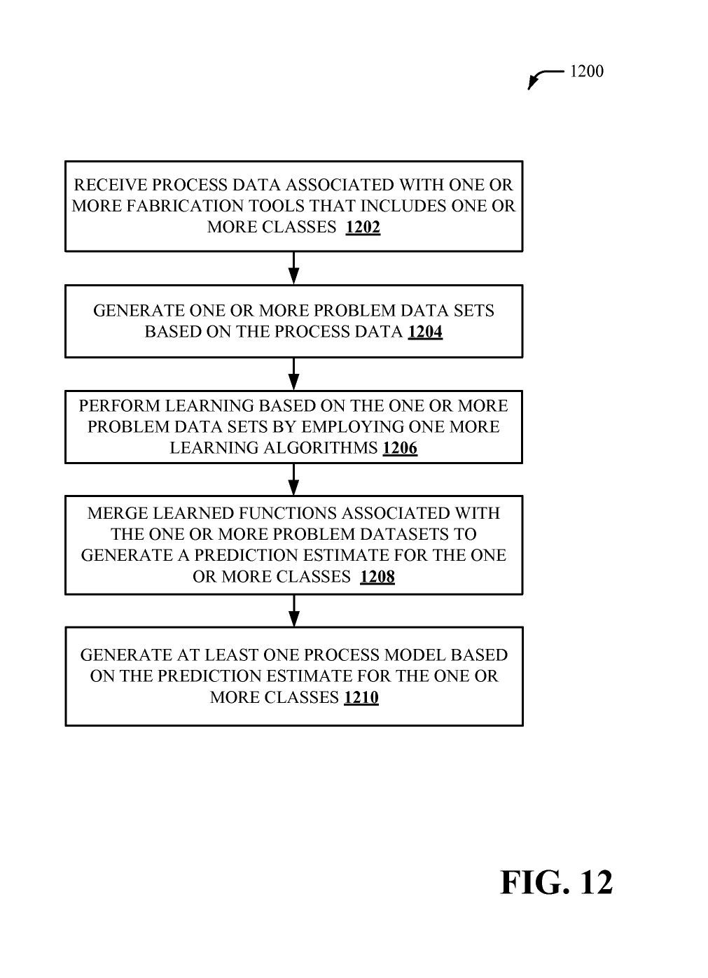

FIGS. 12-14 illustrate various methodologies in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 12 illustrates an example methodology 1200 for generating a process model in accordance with various aspects and implementations of this disclosure. Initially, at 1202, process data associated with one or more fabrication tools that includes one or more classes is received (e.g., by a model component 160). For example, process data can include sensor measurement data, spectral data, device measurement data and/or classification data. At 1204, one or more problem data sets are generated (e.g., by a model component 160) based on the process data. For example, one or more binary classification datasets can be generated based on process data, one or more ternary classification datasets can be generated based on process data, etc. At 1206, learning is performed (e.g., by a model component 160) based on the one or more problem data sets by employing one or more learning algorithms. For example, one or more learned functions can be generated for each of the problem data sets based on one or more learning algorithms. At 1208, learned functions associated with the one or more problem datasets are merged (e.g., by a model component 160) to generate a prediction estimate for the one or more classes. For example, the one or more learned functions (e.g., one or more learned models) for each of the problem datasets can be merged. At 1210, at least one process model is generated (e.g., by a model component 160) based on the prediction estimate for the one or more classes. For example, at least one predictive process model can be generated for the process data associated with the one or more fabrication tools based on the prediction estimate for the one or more classes.

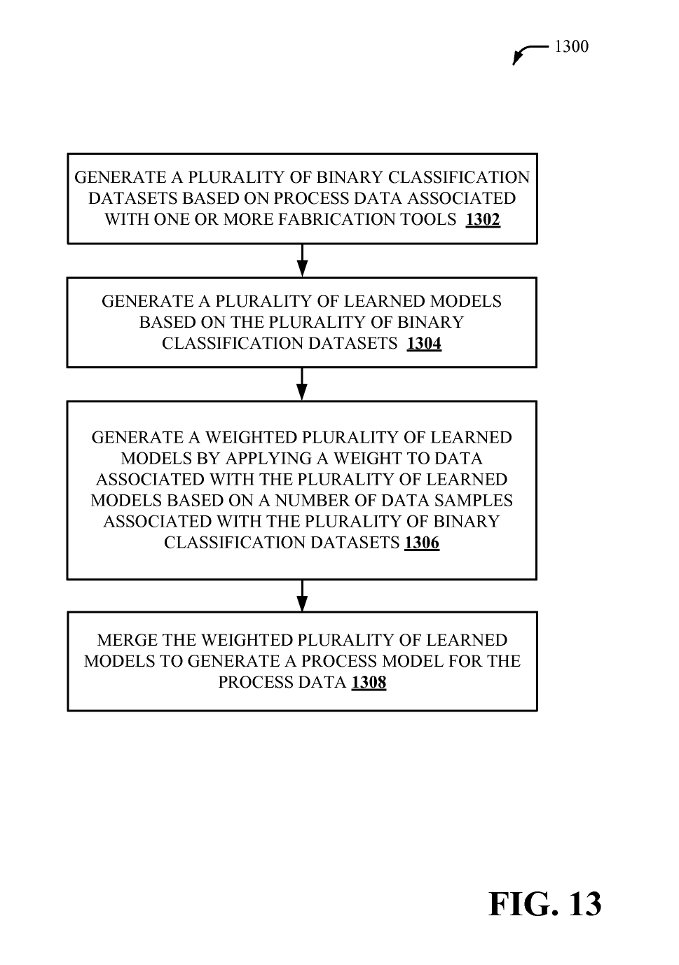

FIG. 13 illustrates an example methodology 1300 for generating a process model in accordance with various aspects and implementations of this disclosure. Initially, at 1302, a plurality of binary classification datasets are generated (e.g., by a dataset component 204) based on process data associated with one or more fabrication tools. However, it is to be appreciated that a plurality of different classification datasets (e.g., a plurality of ternary classification datasets, a plurality of quaternion classification datasets, etc.) can be generated based on process data associated with one or more fabrication tools. At 1304, a plurality of learned models is generated (e.g., by a learning component 206) based on the plurality of binary classification datasets. For example, a plurality of learned binary models can be generated based on the plurality of binary classification datasets (or a plurality of learned ternary models can be generated based on a plurality of ternary classification datasets, etc.). At 1306, a weighted plurality of learned models is generated (e.g., by a learning component 206) by applying a weight to data associated with the plurality of learned models based on a number of data samples associated with the plurality of binary classification datasets. For example, a weighted plurality of learned binary models (or a weighted plurality of learned ternary models, etc.) can be generated. At 1308, the weighted plurality of learned models are merged (e.g., by a merging component 208) to generate a process model for the process data.

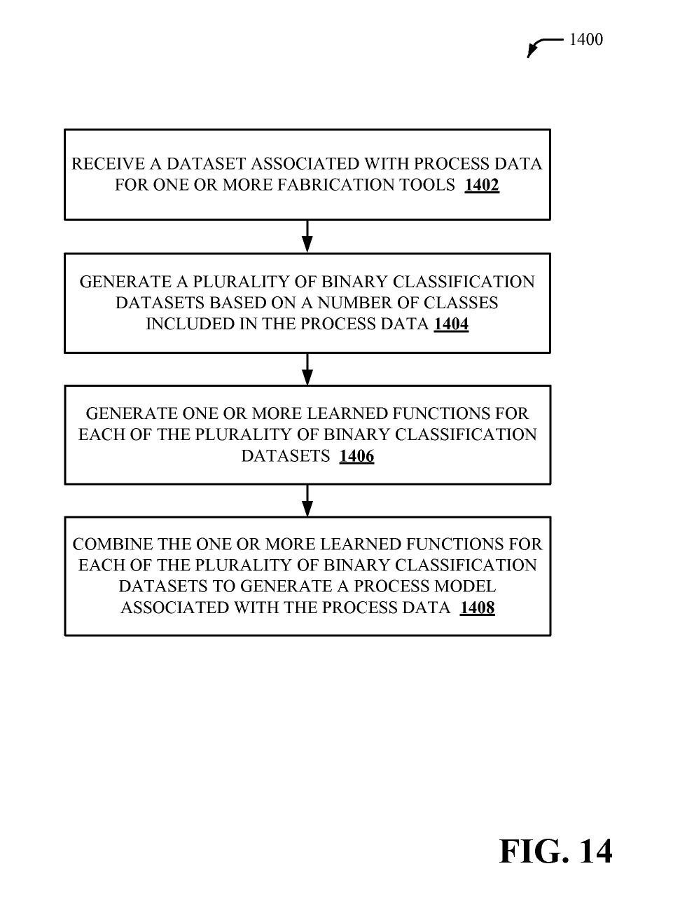

FIG. 14 illustrates an example methodology 1400 for generating a process model in accordance with various aspects and implementations of this disclosure. Initially, at 1402, a dataset associated with process data for one or more fabrication tools is received (e.g., by a reporting component 202). At 1404, a plurality of binary classification datasets are generated (e.g., by a dataset component 204) based on a number of classes included in the process data. For example, a plurality of binary classification datasets can be generated based on a number of classifiers associated with the process data. However, it is to be appreciated that a plurality of different classification datasets (e.g., a plurality of ternary classification datasets, a plurality of quaternion classification datasets, etc.) can be generated based on number of classes included in the process data. At 1406, one or more learned functions are generated (e.g., by a learning component 206) for each of the plurality of binary classification datasets. For example, one or more learned binary models can be generated for each of the plurality of binary classification datasets (or one or more learned ternary models can be generated for each of a plurality of ternary classification datasets, etc.). At 1408, the one or more learned functions for each of the plurality of binary classification datasets are combined (e.g., by a merging component 208) to generate a process model associated with the process data.

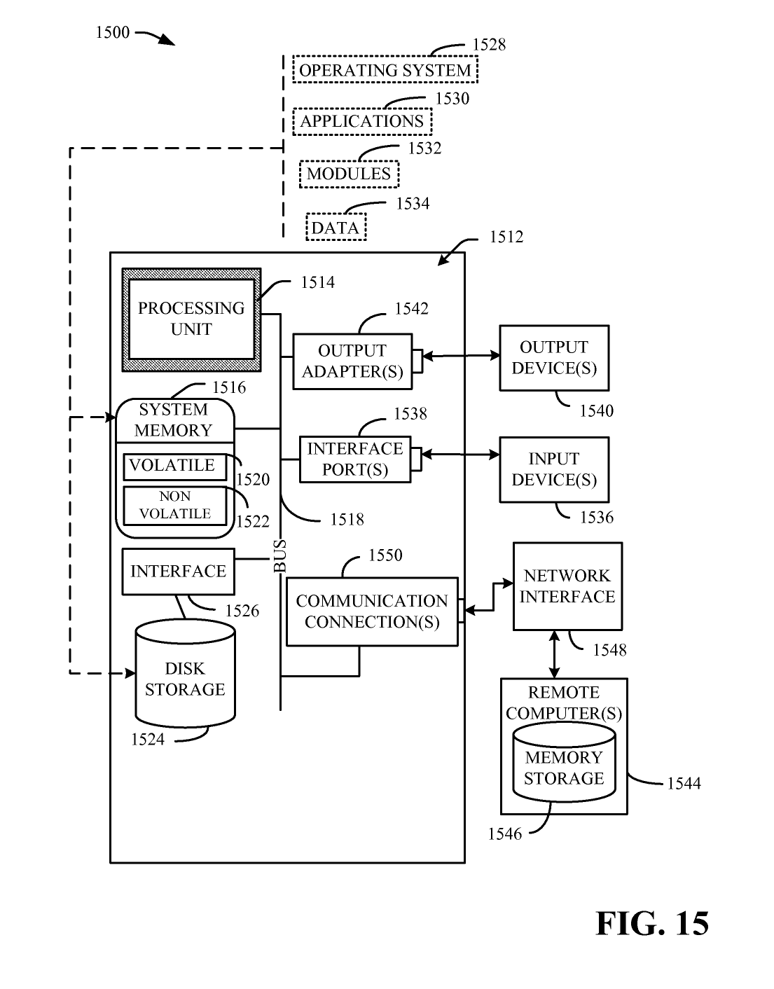

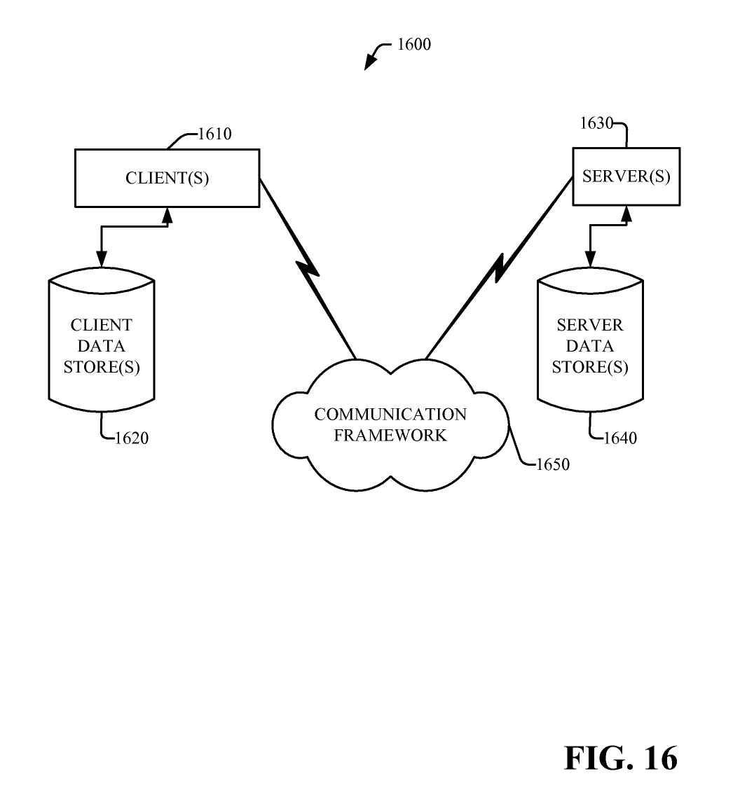

In order to provide a context for the various aspects of the disclosed subject matter, FIGS. 15 and 16 as well as the following discussion are intended to provide a brief, general description of a suitable environment in which the various aspects of the disclosed subject matter may be implemented.

With reference to FIG. 15, a suitable environment 1500 for implementing various aspects of this disclosure includes a computer 1512. The computer 1512 includes a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514.

The system bus 1518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1520 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1512 also includes removable/non-removable, volatile/nonvolatile computer storage media. FIG. 15 illustrates, for example, a disk storage 1524. Disk storage 1524 includes, but is not limited to, devices like a magnetic disk drive, floppy disk drive, tape drive, Jaz drive, Zip drive, LS-100 drive, flash memory card, or memory stick. The disk storage 1524 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to the system bus 1518, a removable or non-removable interface is typically used, such as interface 1526.

FIG. 15 also depicts software that acts as an intermediary between users and the basic computer resources described in the suitable operating environment 1500. Such software includes, for example, an operating system 1528. Operating system 1528, which can be stored on disk storage 1524, acts to control and allocate resources of the computer system 1512. System applications 1530 take advantage of the management of resources by operating system 1528 through program modules 1532 and program data 1534, e.g., stored either in system memory 1516 or on disk storage 1524. It is to be appreciated that this disclosure can be implemented with various operating systems or combinations of operating systems.

A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port may be used to provide input to computer 1512, and to output information from computer 1512 to an output device 1540. Output adapter 1542 is provided to illustrate that there are some output devices 1540 like monitors, speakers, and printers, among other output devices 1540, which require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1550 refers to the hardware/software employed to connect the network interface 1548 to the bus 1518. While communication connection 1550 is shown for illustrative clarity inside computer 1512, it can also be external to computer 1512. The hardware/software necessary for connection to the network interface 1548 includes, for exemplary purposes only, internal and external technologies such as, modems including regular telephone grade modems, cable modems and DSL modems, ISDN adapters, and Ethernet cards.

FIG. 16 is a schematic block diagram of a sample-computing environment 1600 with which the subject matter of this disclosure can interact. The system 1600 includes one or more client(s) 1610. The client(s) 1610 can be hardware and/or software (e.g., threads, processes, computing devices). The system 1600 also includes one or more server(s) 1630. Thus, system 1600 can correspond to a two-tier client server model or a multi-tier model (e.g., client, middle tier server, data server), amongst other models. The server(s) 1630 can also be hardware and/or software (e.g., threads, processes, computing devices). The servers 1630 can house threads to perform transformations by employing this disclosure, for example. One possible communication between a client 1610 and a server 1630 may be in the form of a data packet transmitted between two or more computer processes.

The system 1600 includes a communication framework 1650 that can be employed to facilitate communications between the client(s) 1610 and the server(s) 1630. The client(s) 1610 are operatively connected to one or more client data store(s) 1620 that can be employed to store information local to the client(s) 1610. Similarly, the server(s) 1630 are operatively connected to one or more server data store(s) 1640 that can be employed to store information local to the servers 1630.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory storing computer executable components; and
a processor configured to execute the following computer executable components stored in the memory:
a dataset component that generates a plurality of binary classification datasets based on process data associated with one or more fabrication tools;
a learning component that generates a plurality of learned models based on the plurality of binary classification datasets and applies a weight to the plurality of learned models based on a number of data samples associated with the plurality of binary classification datasets to generate a weighted plurality of learned models; and
a merging component that merges the weighted plurality of learned models to generate a process model for the process data.

2. The system of claim 1, wherein the dataset component generates the plurality of binary classification datasets based on modified process data that includes replicated data.

3. The system of claim 1, wherein the dataset component generates the plurality of binary classification datasets based on modified process data that includes summarized data.

4. The system of claim 1, wherein the dataset component generates the plurality of binary classification datasets based on a data matrix that includes at least one of sensor measurement data, spectral data and classifier data.

5. The system of claim 1, wherein the dataset component generates the plurality of binary classification datasets according to a number of different classes included in the process data.

6. The system of claim 1, further comprising an output component that outputs the process model as a library of functions for predicting a classification of a unit of processing.

7. The system of claim 1, further comprising an output component that outputs the process model as a single function for predicting a classification of a unit of processing.

8. The system of claim 1, further comprising an analysis component that predicts a classification of a unit of processing based on the process model.

9. The system of claim 8, wherein the analysis component determines one or more input parameters associated with a particular classification for a unit of processing based on the process model.

10. The system of claim 9, wherein the analysis component ranks the one or more input parameters associated with the particular classification for the unit of processing.

11. A method, comprising:
employing a processor that facilitates execution of computer executable instructions stored on a non-transitory computer readable medium to implement operations, comprising:
receiving a dataset associated with process data for one or more fabrication tools;
generating a plurality of classification datasets based on a number of classes included in the process data;
generating one or more learned functions for each of the plurality of classification datasets; and
combining the one or more learned functions for each of the plurality of classification datasets to generate a process model associated with the process data.

12. The method of claim 11, wherein the generating the plurality of classification datasets comprises generating the plurality of classification datasets based on modified process data that includes replicated data.

13. The method of claim 11, wherein the generating the plurality of classification datasets comprises generating the plurality of classification datasets based on modified process data that includes summarized data.

14. The method of claim 11, wherein the generating the plurality of classification datasets comprises generating the plurality of classification datasets based on a data matrix that includes at least one of sensor measurement data, spectral data and classifier data.

15. The method of claim 11, wherein the generating the plurality of classification datasets comprises generating a classification dataset for each of the different classes included in the process data.

16. The method of claim 11, further comprising:
predicting a classification of a unit of processing based on the process model.

17. The method of claim 11, further comprising:
determining one or more input parameters associated with a particular classification for a unit of processing based on the process model.

18. A computer-readable medium having stored thereon computer-executable instructions that, in response to execution by a system including a processor, cause the system to perform operations, the operations including:
generating a plurality of binary classification datasets associated with a unique classification for a unit of processing based on process data;
generating one more learned functions for each of the plurality of binary classification datasets; and
generating a process model for the process data by merging the one more learned functions for each of the plurality of binary classification datasets.

19. The computer-readable medium claim 18, wherein the generating the plurality of binary classification datasets comprises generating the plurality of binary classification datasets based on a data matrix that includes at least one of sensor measurement data, spectral data and classifier data.

20. The computer-readable medium claim 18, wherein the generating the plurality of binary classification datasets comprises generating the plurality of binary classification datasets according to a number of different classes included in the process data.
